(19) United States
(12) Patent Application Publication
(10) Pub. No.: US 2011/0018876 A1
(43) Pub. Date: Jan. 27, 2011

(54) Systems and Methods for Determining Lighting for 3D Geometry

(75) Inventor: Alexander Nankervis, Austin, TX (US)

Correspondence Address: Georgios A. Georgakis;Chowdhury & Georgakis, PC, PO BOX 90277, AUSTIN, TX, 78709-0277, US

(73) Assignee: Zebra Imaging, Inc., Austin, TX (US)

(21) Appl. No.: 12/507,037

(22) Filed: Jul. 21, 2009

(51) Int. Cl. G06T 15/50

(52) U.S. Cl. 345/426

(57) ABSTRACT

Methods and systems for determining lighting values, including providing a set of points around a 3D geometry, the set of points being independent of the 3D geometry, determining a depth map of the 3D geometry with respect to a view point by projecting the 3D geometry according to the view point, and determining visibility values for the set of points by comparing the set of points to the depth map of the 3D geometry.

### I. BACKGROUND

The invention relates generally to the field of determining and applying lighting values to 3D geometry.

### II. SUMMARY

In one respect, disclosed is a method for determining lighting values, the method comprising: providing a set of points around a 3D geometry, the set of points being independent of the 3D geometry; determining a depth map of the 3D geometry with respect to a view point by projecting the 3D geometry according to the view point; and determining visibility values for the set of points by comparing the set of points to the depth map of the 3D geometry.

In another respect, disclosed is a system for determining lighting values, the system comprising: one or more processors; and one or more memory units coupled to the processor, the system being configured to: be provided a set of points around a 3D geometry, the set of points being independent of the 3D geometry; determine a depth map of the 3D geometry with respect to a view point by projecting the 3D geometry according to the view point; and determine visibility values for the set of points by comparing the set of points to the depth map of the 3D geometry.

In yet another respect, disclosed is a computer program product stored on a computer operable medium, the computer program product comprising software code being effective to: be provided a set of points around a 3D geometry, the set of points being independent of the 3D geometry; determine a depth map of the 3D geometry with respect to a view point by projecting the 3D geometry according to the view point; and determine visibility values for the set of points by comparing the set of points to the depth map of the 3D geometry.

Numerous additional embodiments are also possible. In one or more various aspects, related articles, systems, and devices include but are not limited to circuitry, programming, electromechanical devices, or optical devices for effecting the herein referenced method aspects; the circuitry, programming, electromechanical devices, or optical devices can be virtually any combination of hardware, software, and firmware configured to effect the herein referenced method aspects depending upon the design choices of the system designer skilled in the art.

The foregoing is a summary and thus contains, by necessity, simplifications, generalizations and omissions of detail; consequently, those skilled in the art will appreciate that the summary is illustrative only and is not intended to be in any way limiting. Other aspects, features, and advantages of the devices, processes, or other subject matter described herein will become apparent in the teachings set forth herein.

In addition to the foregoing, various other method, device, and system aspects are set forth and described in the teachings such as the text (e.g., claims or detailed description) or drawings of the present disclosure.

### III. BRIEF DESCRIPTION OF THE DRAWINGS

Other aspects and advantages of the invention may become apparent upon reading the detailed description and upon reference to the accompanying drawings.

FIG. 1 is a block diagram illustrating an ambient occlusion engine, in accordance with some embodiments.

FIG. 2 is a diagram illustrating a method for determining ambient occlusion values for a 3D geometry, in accordance with some embodiments.

FIG. 3 is a flow diagram illustrating a method for determining ambient occlusion values for a 3D geometry, in accordance with some embodiments.

FIG. 4 is a flow diagram illustrating an alternative method for determining ambient occlusion values for a 3D geometry, in accordance with some embodiments.

FIG. 5 is a flow diagram illustrating yet another alternative method for determining ambient occlusion values for a 3D geometry, in accordance with some embodiments.

### Brief description for the additional figures is provided in the detailed description section.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### IV. DETAILED DESCRIPTION

Certain terms are used throughout the following description and claims to refer to particular system components and configurations. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the terms “couple,” “couples,” “coupled,” or “coupleable” are intended to mean either an indirect or direct electrical or wireless connection. Thus, if a first device couples to a second device, that connection may be through a direct electrical, optical, wireless connection, etc. or through an indirect electrical, optical, wireless connection, etc. by means of other devices and connections.

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art. Other embodiments may be utilized, and other changes may be made, without departing from the spirit or scope of the subject matter presented here.

In some embodiments, systems and methods are disclosed for determining and/or applying lighting values to a 3D geometry. In some embodiments, the 3D geometry may be provided without lighting information; lighting information may be determined by assuming one or more lighting sources illuminating the geometry. In some embodiments, the 3D geometry may be provided in a computer-readable format such as Autodesk FBX, Wavefront OBJ, and other (possibly custom-designed or proprietary) model formats.

In some embodiments, one or more lighting sources may be assumed. The lighting sources may be assumed to be at any point in the 3D space or the lighting sources may be assumed to be at infinity. In some embodiments, lighting sources assumed to be at infinity at multiple stereo angles may be used to simulate ambient lighting conditions. Lighting sources at infinity may be represented by a set of parallel rays, each lighting source corresponding to a given stereo angle, for example.

In some embodiments, a set of points is provided around the 3D geometry, the set of points to be used in determining lighting values at each of the points. The lighting values at each of the points may then be used to determine a lighting texture to be applied to the 3D geometry. The set of points may be chosen such that the set of points substantially encompasses the 3D geometry for which lighting values are to be determined, but the set of points may be otherwise independent of the 3D geometry. In some embodiments, the set of points may form a regular grid of points in 3D space. Other configurations of the set of points may be also possible. In alternative embodiments, instead of being independent of the geometry, the set of points may be chosen in response to and according to examining the 3D geometry.

In some embodiments, a light source may be chosen and the 3D geometry may be projected using the light source as a view point. In embodiments where the chosen light source is considered to be at infinity, an orthographic projection may be accordingly used to project the 3D geometry. For other light sources not at infinity, perspective projections may be more appropriate. In some embodiments, a set of pixels (a grid of pixels, in some embodiments) independent of the 3D geometry and the set of points may be used as the projections surface.

The projections may be used in order to create depth maps for the 3D geometry for each lighting source that indicate a relative distance of the 3D geometry to the lighting source for each projected pixel. In alternative embodiments, in addition to the depth/distance information, transparency information or other advance texturing information for the 3D geometry relative to the lighting source may also be determined and stored. Transparency and other related texture information may be used for more advanced lighting value calculations.

For each point in the set of points, a visibility value is then determined by comparing the coordinates of each of the points to the generated depth map. In some embodiments, a visibility of 1 may be assigned to the points that are visible to the lighting source (by being in front of the 3D geometry) and a visibility of 0 may be assigned to the points that are invisible to the lighting source by being behind the 3D geometry. In alternative embodiments, more involved schemes may be employed. For example, information about depth as well as transparency information and other advanced texture information may be used in order to determine more accurate lighting values for each point. That is, the computed lighting values may be determined as something other than a simple 1 or 0.

A similar process may be performed for additional lighting sources. For each point, the lighting values may then be averaged to determine averaged lighting/visibility values for each point from all of the lighting sources. In some embodiments, averaging of the lighting values from multiple lighting sources simulates the effect of ambient light on the 3D geometry. The averaged lighting/visibility values may then be used to create a lighting texture map that may be applied to the 3D geometry in order to represent the lighting of the 3D geometry by the one or more lighting sources.

In some embodiments, a small and/or random amount may be applied to the locations of the set of points in order to create a smoothing effect for the lighting from the one or more lighting sources.

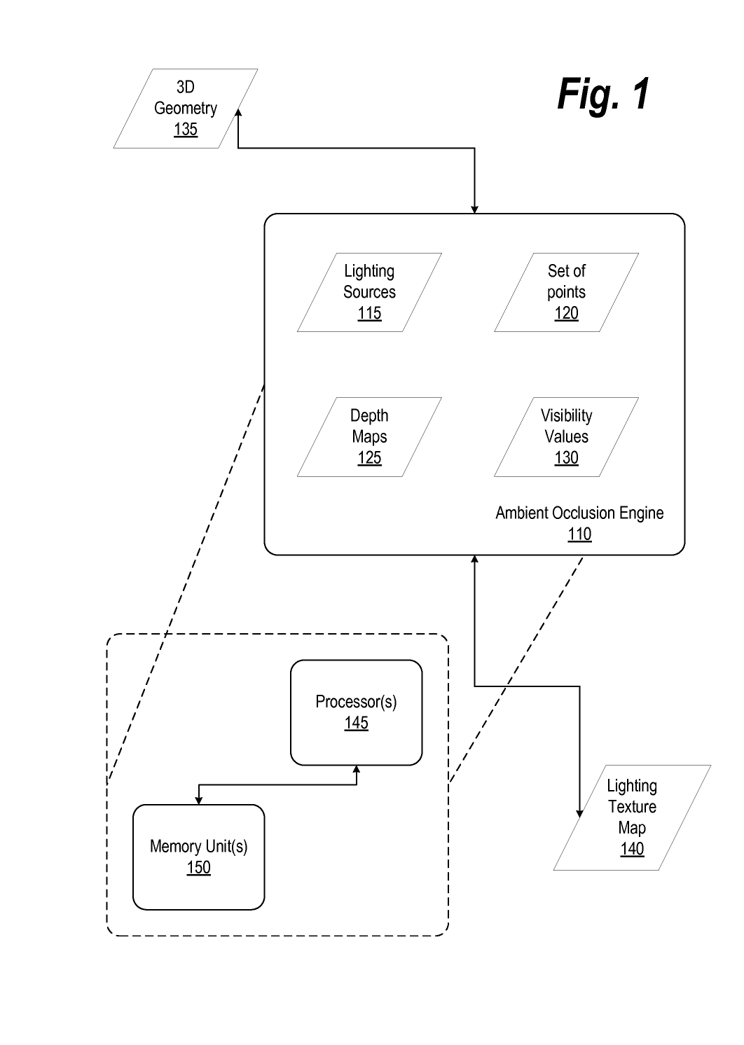

FIG. 1 is a block diagram illustrating an ambient occlusion engine, in accordance with some embodiments.

In some embodiments, ambient occlusion engine 110 is configured to receive 3D geometry 135 and generate lighting texture map 140 that can be applied to 3D geometry 135. In some embodiments, ambient occlusion engine 110 may be implemented using one or more processors 145 and one or memory units 150 that are coupled to one or more processors 145. The memory units and processors are configured to store and execute one or more instructions that are effective to implement the functionality of ambient occlusion engine 110.

Ambient Occlusion Engine 110 is configured to be provided with 3D geometry in various 3D formats such as Autodesk FBX, Wavefront OBJ, and other (possibly custom-designed or proprietary) model formats.

In some embodiments, lighting/visibility values that are to be applied to the 3D geometry are determined according to one or more lighting sources 115. In some embodiments, set of points 120 is provided, the set of points being around 3D geometry 135. The set of points may be independent of the 3D geometry and may be chosen such that the set of points substantially encompasses the 3D geometry for which lighting values are to be determined. In some embodiments, the set of points may form a regular grid of points in 3D space.

In some embodiments, for a given lighting source, the 3D geometry is projected using that lighting source as a view point. The projection may be used in order to create a depth map for the 3D geometry that indicates a relative distance of the 3D geometry to the lighting source. Each generated depth map may be stored in depth maps 125. For each point in the set of points, a visibility value may be determined by comparing the coordinates of each of the points to the generated depth map. In some embodiments, a visibility of 1 may be assigned to the points that are visible to the lighting source (by being in front of the 3D geometry) and a visibility of 0 may be assigned to the points that are invisible to the lighting source by being behind the 3D geometry.

A similar process may be performed for other lighting sources. For each point, the lighting results may then be averaged to determine an averaged lighting/visibility values for each point from all of the lighting sources. The averaged visibility values may be stored in visibility values 130. The averaged lighting/visibility values may then be used to create lighting texture map 140. In some embodiments, that may be applied to the 3D geometry in order to represent lighting of the 3D geometry by the one or more lighting sources.

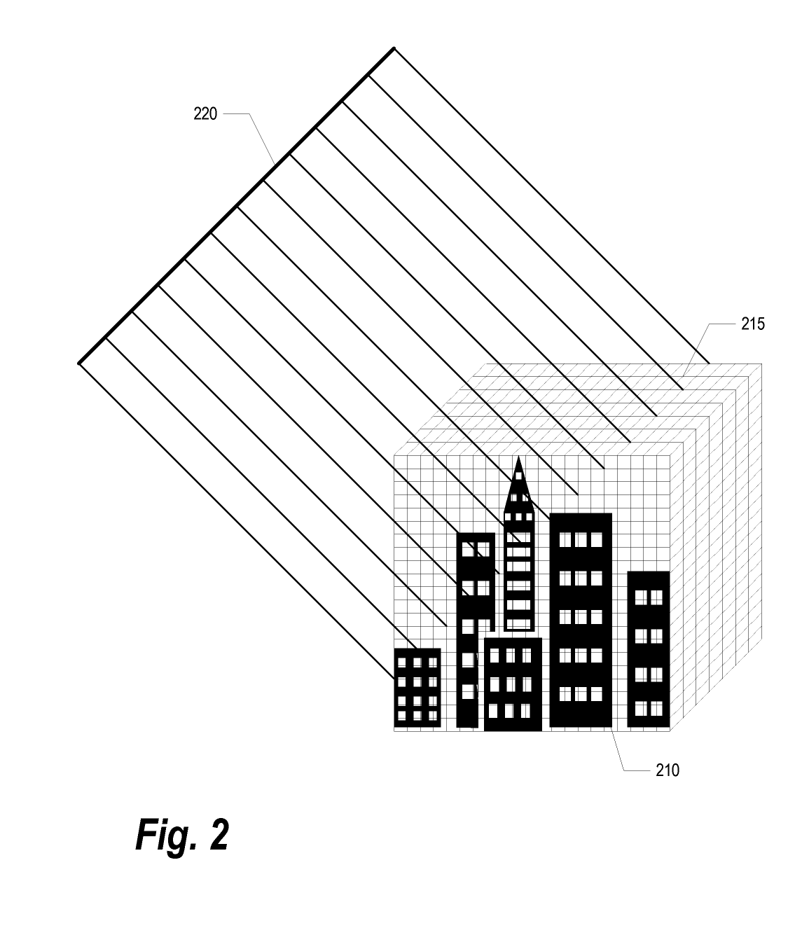

FIG. 2 is a diagram illustrating a method for determining ambient occlusion values for a 3D geometry, in accordance with some embodiments.

In some embodiments, ambient occlusion lighting values are determined for 3D geometry 210. A set of points may be determined, such as regular 3D grid 215, around 3D geometry 210. Other sets of points around 3D geometry 210 may also be used. 3D geometry 210 is projected using one of a set of lighting sources as a projection point in order to generate depth map 220. Depth map 220 indicates a depth or distance of the 3D geometry to the projection point or lighting source. 3D geometry 210 may be similarly projected with additional lighting sources/projections points to generate additional depth maps. In the example shown, the lighting source is assumed to be at infinity, and therefore, an orthographic projection (indicated by the parallel projection rays) is used to generate depth map 220. Visibility or lighting values for each point in grid 215 may be then determined by comparing the depth of each point to depth map 220. If a point is above the 3D geometry, the point is visible and is assigned a value of 1; and if the point is below the 3D geometry, the point is not visible and is assigned a value of 0. The visibility for each point may be then averaged across multiple lighting sources to determine an averaged visibility for each point. A lighting texture map may be generated from the averaged visibility values and applied to the 3D geometry.

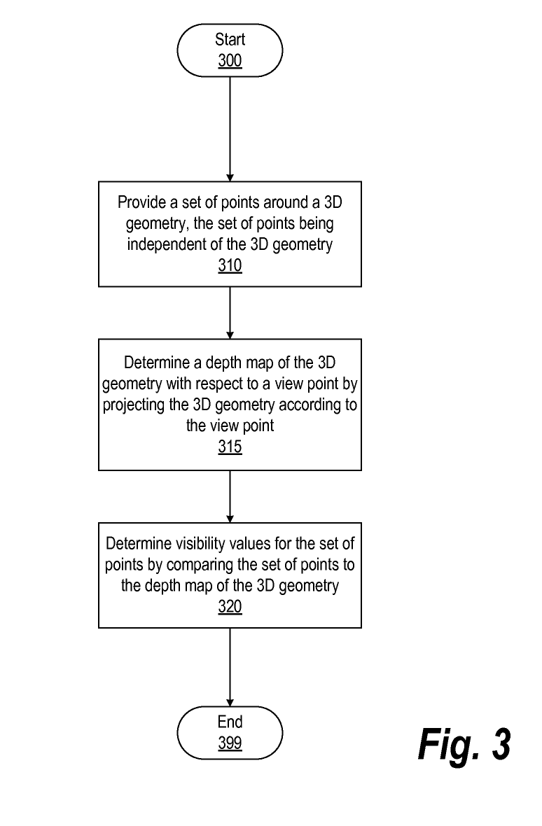

FIG. 3 is a flow diagram illustrating a method for determining ambient occlusion values for a 3D geometry, in accordance with some embodiments. It should be noted that, in some embodiments, the methods described here may be performed by the system described in FIG. 1.

Processing begins at 300 whereupon, at block 310, a set of points is provided around a 3D geometry. In some embodiments, the set of points is chosen independently of the shape of the 3D geometry.

At block 315, a depth map of 3D geometry is determined with respect to a view point/lighting source by projecting the 3D geometry according to the view point.

At block 320, visibility values are determined for the set of points by comparing the set of points to the depth map of the 3D geometry.

Processing subsequently ends at 399.

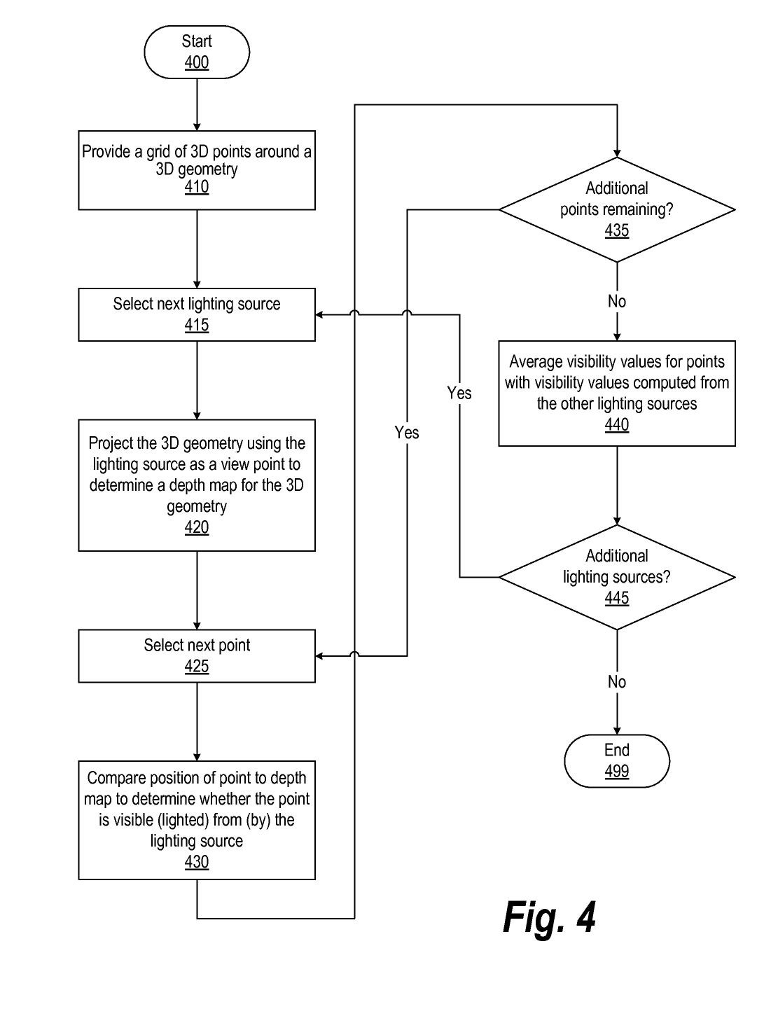

FIG. 4 is a flow diagram illustrating an alternative method for determining ambient occlusion values for a 3D geometry, in accordance with some embodiments. It should be noted that, in some embodiments, the methods described here may be performed by the system described in FIG. 1.

Processing begins at 400 whereupon, at block 410, a grid of 3D points is provided around a 3D geometry. In some embodiments, the grid of 3D points may be used to calculate lighting values from one or more lighting sources. The lighting values may be used to apply lighting textures to the 3D geometry.

At block 415, the next lighting source is selected (or the only lighting source is selected if only one lighting source is being used).

At block 420, the 3D geometry is projected using the lighting source as a view point to determine a depth map for the 3D geometry. The depth map represents a distance from the 3D geometry to the lighting source.

At block 425, the next point in the grid of 3D points is selected.

At block 430, the position of the selected point is compared to the depth map to determine whether the point is visible (lighted) from (by) the view point (lighting source). If a point is closer to the lighting source than the 3D geometry, the point is visible (lighted); otherwise, the point is not visible.

At decision 435, a determination is made as to whether additional points remain. If additional points remain, decision 435 branches to the “yes” branch where processing returns to block 425 where the next point is selected.

Otherwise, if no additional points remain, decision 435 branches to the “no” branch where, at block 440, visibility values for each point are averaged with visibility values calculated from previous lighting sources to generate averaged lighting values for each point.

At decision 445, a determination is made as to whether additional lighting sources remain. If additional lighting sources remain, decision 445 branches to the “yes” branch with processing returning to block 415 where the next lighting source is selected.

On the other hand, if no additional lighting sources remain, decision 445 branches to the “no” branch where processing subsequently ends at 499.

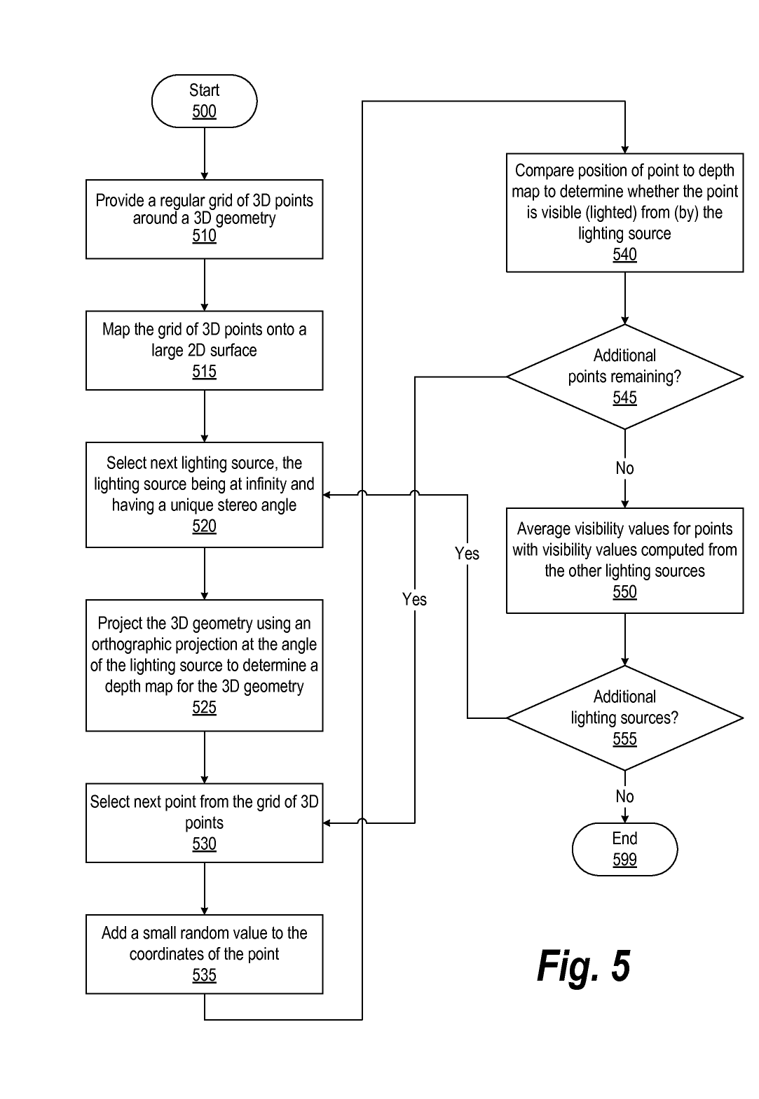

FIG. 5 is a flow diagram illustrating yet another alternative method for determining ambient occlusion values for a 3D geometry, in accordance with some embodiments. It should be noted that, in some embodiments, the methods described here may be performed by the system described in FIG. 1.

Processing begins at 500 whereupon, at block 510, a grid of 3D points is provided around a 3D geometry. In some embodiments, the grid of 3D points may be used to calculate lighting values from one or more lighting sources. The lighting values may be used to apply lighting textures to the 3D geometry.

At block 515, the grid of 3D points is mapped onto a large 2D grid by laying out slices of the 3D grid. In some embodiments, the mapping is performed in order to take advantage of the efficiency with which graphics processing units can process 2D grids of data.

At block 520, the next lighting source is selected (or the only lighting source is selected if only one lighting source is being used). In some embodiments, the lighting sources may be assumed to be at infinity, in which case each different lighting source will have a different stereo angle from which light rays from the lighting source are assumed to be originating.

At block 525, the 3D geometry is projected using the lighting source as a view point to determine a depth map for the 3D geometry. The depth map represents a distance from the 3D geometry to the lighting source. In an embodiment where lighting sources at infinity are used, an orthographic projection may be used to project the 3D geometry towards the lighting source.

At block 530, the next point in the grid of 3D points is selected.

At block 535, a small value (random, in some embodiments) may be added to the coordinates of each point from the grid of 3D points. In some embodiments, the small values may be added in order to obtain a smoother distribution of lighting values when the lighting values are later determined.

At block 540, the position of the selected point is compared to the depth map to determine whether the point is visible (lighted) from (by) the view point (lighting source). If a point is closer to the lighting source than the 3D geometry, the point is visible (lighted); otherwise, the point is not visible.

At decision 545, a determination is made as to whether additional points remain. If additional points remain, decision 545 branches to the “yes” branch where processing returns to block 530 where the next point is selected.

Otherwise, if no additional points remain, decision 545 branches to the “no” branch where, at block 550, visibility values for each point are averaged with visibility values calculated from previous lighting sources to generate averaged lighting values for each point.

At decision 555, a determination is made as to whether additional lighting sources remain. If additional lighting sources remain, decision 555 branches to the “yes” branch with processing returning to block 520 where the next lighting source is selected.

On the other hand, if no additional lighting sources remain, decision 555 branches to the “no” branch where processing subsequently ends at 599.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method for determining lighting values, the method comprising:
providing a set of points around a 3D geometry, the set of points being independent of the 3D geometry;
determining a depth map of the 3D geometry with respect to a view point by projecting the 3D geometry according to the view point; and
determining visibility values for the set of points by comparing the set of points to the depth map of the 3D geometry.

2. The method of claim 1, further comprising:
determining additional depth maps of the 3D geometry with respect to additional view points by projecting the 3D geometry according to the additional view points;
determining additional visibility values for the set of points by comparing the set of points to the additional depth maps of the 3D geometry; and
averaging the visibility values and the additional visibility values to determine averaged visibility values for the set of points.

3. The method of claim 2, further comprising generating a lighting texture map using the averaged visibility values.

4. The method of claim 3, further comprising applying the lighting texture map to the 3D geometry.

5. The method of claim 1, further comprising:
mapping the set of points onto a large 2D grid of points; and
performing the determining the depth map and the determining the visibility values using a GPU.

6. The method of claim 1, further comprising adding a small offset to positions of the set of points.

7. A system for determining lighting values, the system comprising:
one or more processors; and
one or more memory units coupled to the processor,
the system being configured to:
be provided a set of points around a 3D geometry, the set of points being independent of the 3D geometry;
determine a depth map of the 3D geometry with respect to a view point by projecting the 3D geometry according to the view point; and
determine visibility values for the set of points by comparing the set of points to the depth map of the 3D geometry.

8. The system of claim 7, being further configured to:
determine additional depth maps of the 3D geometry with respect to additional view points by projecting the 3D geometry according to the additional view points;
determine additional visibility values for the set of points by comparing the set of points to the additional depth maps of the 3D geometry; and
average the visibility values and the additional visibility values to determine averaged visibility values for the set of points.

9. The system of claim 8, being further configured to generate a lighting texture map using the averaged visibility values.

10. The system of claim 9, being further configured to apply the lighting texture map to the 3D geometry.

11. The system of claim 7, being further configured to:
map the set of points onto a large 2D grid of points; and
perform the determining the depth map and the determining the visibility values using a GPU.

12. The system of claim 7, being further configured to add a small offset to positions of the set of points.

13. A computer program product stored on a computer operable medium, the computer program product comprising software code being effective to:
be provided a set of points around a 3D geometry, the set of points being independent of the 3D geometry;
determine a depth map of the 3D geometry with respect to a view point by projecting the 3D geometry according to the view point; and
determine visibility values for the set of points by comparing the set of points to the depth map of the 3D geometry.

14. The product of claim 13, where the code is further effective to:
determine additional depth maps of the 3D geometry with respect to additional view points by projecting the 3D geometry according to the additional view points;
determine additional visibility values for the set of points by comparing the set of points to the additional depth maps of the 3D geometry; and
average the visibility values and the additional visibility values to determine averaged visibility values for the set of points.

15. The product of claim 14, where the code is further effective to generate a lighting texture map using the averaged visibility values.

16. The product of claim 15, where the code is further effective to apply the lighting texture map to the 3D geometry.

17. The product of claim 13, where the code is further effective to:
map the set of points onto a large 2D grid of points; and
perform the determining the depth map and the determining the visibility values using a GPU.

18. The product of claim 13, where the code is further effective to add a small offset to positions of the set of points.
